(19) United States
(12) Patent Application Publication
(10) Pub. No.: US 2017/0103383 A1
(43) Pub. Date: Apr. 13, 2017

(54) METHODS AND SYSTEMS FOR DETERMINING CARDHOLDER LOCATION WHEN A TRANSACTION TAKES PLACE

(71) Applicant: MASTERCARD INTERNATIONAL INCORPORATED, Purchase, NY (US)

(72) Inventors: MAYANK PRAKASH, Dehradun (IN); SHEETANSHU D. GUPTA, Jaipur (IN); ASHUTOSH SHARAN, Gurgaon (IN)

(21) Appl. No.: 15/292,455

(22) Filed: Oct. 13, 2016

(30) Foreign Application Priority Data
Oct. 13, 2015 (SG) 10201508473W

(51) Int. Cl. G06Q 20/34; G06Q 20/32

(52) U.S. Cl. CPC G06Q 20/34; G06Q 20/3224

(57) ABSTRACT

A computer system and method for determining a cardholder location during Card Not Present (CNP) transaction. The system comprises first, second and third databases, and a location engine comprising a processor operable by instructions stored in memory that, when executed by the processor, cause the processor, during use of the payment card during a CNP transaction with a first one of the plurality of merchants determine the location of the cardholder during the CNP transaction.

### FIELD OF THE INVENTION

The present invention relates to a method and system for determining a cardholder's location when a transaction takes place. In particular, the invention relates to analysis of payment card transaction data in relation to Card Not Present (CNP) cross-border commercial transactions. This may involve differentiating between cross-border transactions performed (e.g. online) from a cardholder's domestic country as opposed to a transaction carried out by the cardholder in a foreign country.

### BACKGROUND

Payment card fraud is conventionally detected using a scoring system in which a transaction is rejected if a high score is found, indicating a sufficient number of sufficiently suspicious transactions. An aim of the present invention is to improve the scoring system in relation to CNP cross-border transactions, which generally have a higher probability of fraud.

A significant number of cross-border online transactions are performed by cardholders from their home country, while a lot of transactions are also done in the country of the merchant while a customer is visiting that country. However, there is currently no way to differentiate between these two types of online cross-border transactions.

Most online merchants have their online payments server registered in one particular country such that all online transactions are routed to the registered country no matter from which country a cardholder is doing the transaction. Consequently, it is difficult to track whether the online transaction is performed by a cardholder from their domestic country, whether the cardholder is actually present in the merchant country, or whether the card is being used fraudulently. It is therefore an aim of the present invention to determine the cardholder's location when cross-border transactions are performed such that a fraud detection scoring system can be improved.

This problem is particular to so-called Card Not Present (CNP) transactions where the payment card is not present at a point of sale (POS); for example, when the card is used online or for telephone payments. In such situations, the cardholder or telephone operator keys the card number into a computer system. The opposite situation is a so-called Card Present (CP) transaction, where the card is generally scanned at the POS.

As used in this document, the term “payment card” refers to any suitable cashless payment device, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, transponder devices, NFC-enabled devices, and/or computers.

### SUMMARY OF THE INVENTION

In general, the present invention aims to provide methods and systems for improved detection of payment card fraud through more detailed analysis of CNP cross-border transactions.

In a first aspect of the invention there is provided a computer system for determining a cardholder's location when a Card Not Present (CNP) transaction takes place comprising:
an issuer database storing issuer countries for payment cards;
a transactional data database storing one or more transactional data records characterising payment card transactions with a plurality of merchants;
a merchant database storing merchant countries where each merchant has a registered address and/or a registered payment server; and
a location engine which is operative to carry out the following steps:
   (i) check whether an issuer country is the same as a merchant country for a particular payment card transaction, and, if so, determine that the cardholder is in the issuer/merchant country;
   (ii) otherwise carry out the following steps:
      a) check whether, within a first pre-defined time frame, a cardholder performed a Card Present (CP) transaction;
      b) if the answer to step a) is positive, determine the cardholder location as the location of the CP transaction that took place at a time closest to a time of the CNP transaction concerned;
      c) if the answer to step a) is negative, check whether, within a second pre-defined time frame, a transaction was carried out with an airline, car rental or accommodation merchant and, if so, determine that the cardholder is in the country of the airline, car rental or accommodation merchant.

Embodiments of the present invention have the advantage that fraud detection can be improved by determining the likely location of the cardholder at the time of a transaction. Not only can cross-border transactions be sub-categorised as either being initiated by cardholders in their home country or carried out whilst the cardholder is overseas, but also, a more accurate assessment of a cardholder's spend pattern can be achieved, which may be useful in creating marketing strategies for merchants and card issuers. Furthermore, aspects of the invention can provide data for merchants regarding their share of online cross-border transactions versus online domestic transactions. In addition, marketeers may use data obtained from embodiments of the present invention to run special campaigns for cardholders travelling overseas.

It will be understood that, although an aim of the invention is to determine the location of a cardholder when a transaction takes place, the determination itself may not occur until a time after the transaction has taken place to allow analysis of data gathered both before and after the transaction in question. For example, the first pre-defined time frame may be based on a number of days around the date on which the transaction concerned took place. More specifically, the first pre-defined time frame may be 1, 2, 3, 4, 5, 6, 7, 10, 14, 21 or 30 days from the date on which the CNP transaction concerned took place. Note, the first pre-defined time frame may be x number of days prior to and/or after the date on which the CNP transaction took place.

In a situation where a CP transaction in country A is noted 1 day before a CNP cross-border transaction, with a CP transaction in country B noted 1 day after, the system may employ a finer time-scale (e.g. hours, minutes or seconds) to determine precisely which CP transaction was performed closest in time to the CNP transaction. Alternatively, the location of the cardholder when the CNP transaction took place could be based on an assessment of whether the CNP transaction was carried out in the same country as A or B. For example, if the CNP transaction was conducted in country A, the system would determine that the most likely location of the cardholder at that time is country A due to the closeness of the CP transaction in country A also.

Embodiments of the invention may be particularly suited to analysis of CNP cross-border transactions.

The location engine may be configured to assign a score to a transaction based on the determination of steps (i) and (ii) and the likelihood that the transaction is fraudulent.

In certain embodiments of the invention, the location of the cardholder may be indeterminate and, in which case, a traditional scoring system may be employed for fraud detection.

The second pre-defined time frame may be based on a number of days prior to or after the date on which the transaction concerned took place. For example, the second pre-defined time frame may be 1, 2, 3, 4, 5, 6, 7, 10, 14, 21 or 30 days or 1, 2 or 3 months prior to or after the date on which the transaction concerned took place.

It will be understood that aspects of the present invention assume that a cardholder generally holds cards issued by card issuers (i.e. banks) in the country in which the cardholder lives or is at least, temporarily resident.

Of course there are also situations in which a cardholder may hold cards issued by banks not in his/her country of residence. For example, where a cardholder living in country A goes to country B, where his/her card is issued, and uses the card to make a CNP transaction from a merchant in country B, this will not be considered a cross-border transaction in embodiments of the present invention.

Furthermore, there may be situations where the cardholder is temporarily in a foreign country, other than the issuer country or the merchant country, when a transaction takes place and this is likely to generate a high score on a fraud detection system unless the card issuer has been notified that the cardholder is travelling to the foreign country.

Embodiments of the invention may be linked to an online wallet system (such as the applicant's MasterPass™ system), in which, rather than a cardholder entering card data, he/she gives the merchant website sufficient information to extract the card data from a database (e.g. operated by the card issuer, or by a payment system operator or payment processor) where this data is stored.

Aspects of the invention may be implemented in the form of a centralised computer system (e.g. a server) which presents an interface to which operators (e.g. payment system operators) may connect (e.g. over the internet). Alternatively, they may be provided as applications running on a computing device owned by a payment system operator, optionally communicating with external database(s).

In a second aspect of the invention there is provided a computerised method for determining a cardholder's location when a Card Not Present (CNP) transaction takes place comprising:
(i) receiving issuer countries for payment cards from an issuer database;
(ii) receiving transactional data from a transactional data database storing one or more transactional data records characterising payment card transactions with a plurality of merchants;
(iii) receiving merchant countries from a merchant database, where each merchant has a registered address and/or registered payment server; and
(iv) checking whether an issuer country is the same as a merchant country for a particular payment card transaction, and, if so, determining that the cardholder is in the issuer/merchant country;
(v) otherwise carrying out the following steps:
   a) checking whether, within a first pre-defined time frame, a cardholder performed a Card Present (CP) transaction;
   b) if the answer to step a) is positive, determining the cardholder location as the location of the CP transaction that took place at a time closest to a time of the CNP transaction concerned;
   c) if the answer to step a) is negative, checking whether, within a second pre-defined time frame, a transaction was carried out with an airline, car rental or accommodation merchant and, if so, determining that the cardholder is in the country of the airline, car rental or accommodation merchant.

The method may further comprise assigning a score to a transaction based on the determination of steps (iv) and (v) and the likelihood that the transaction is fraudulent.

In a third aspect of the invention there is provided a non-transitory computer-readable medium having stored thereon program instructions for causing at least one processor to perform the method according to the second aspect of the invention.

### BRIEF DESCRIPTION OF THE DRAWINGS

Embodiments of the invention will now be described, by way of example only, with reference to the following drawings, in which:

FIG. 1 shows example transactional data by an Indian cardholder;

FIG. 2 is a block diagram of a computer system according to an embodiment of the present invention;

FIG. 3 is a flowchart of a method according to an embodiment of the present invention;

FIG. 4 is a block diagram illustrating a technical architecture of a server that may be employed in embodiments of the invention; and

FIG. 5 is a block diagram illustrating a technical architecture of a user device which may be employed in the implementation of embodiments of the invention.

### DETAILED DESCRIPTION OF CERTAIN EMBODIMENTS

FIG. 1 shows example transactional data 10 by an Indian cardholder (i.e. with a payment card issued by an Indian card issuer). In this example, column 12 lists the merchant countries in which the merchants have a registered payment server for commercial transactions. In addition, column 14 categorises the transactions as being either domestic (i.e. carried out in India) or cross-border (Xborder) if the merchant country 12 is anywhere other than India. However, without employing an embodiment of the present invention it not possible to determine the actual location of the cardholder when these transactions were carried out (i.e. whether the transactions were performed online while the cardholder was in India or whether the cardholder actually travelled to the countries concerned). It is therefore not possible to accurately determine the risk of fraudulent card use based purely on the data presented.

By way of further background, it should be noted that of a random set of 500 Indian cardholders who performed a card not present (CNP) cross-border transaction in December 2014, 40% did a card present domestic transaction either before or after a 7-day period from the point at which the CNP cross-border transaction was done. It therefore may be assumed that the majority (if not all) of these transactions were online cross-border transactions initiated from India.

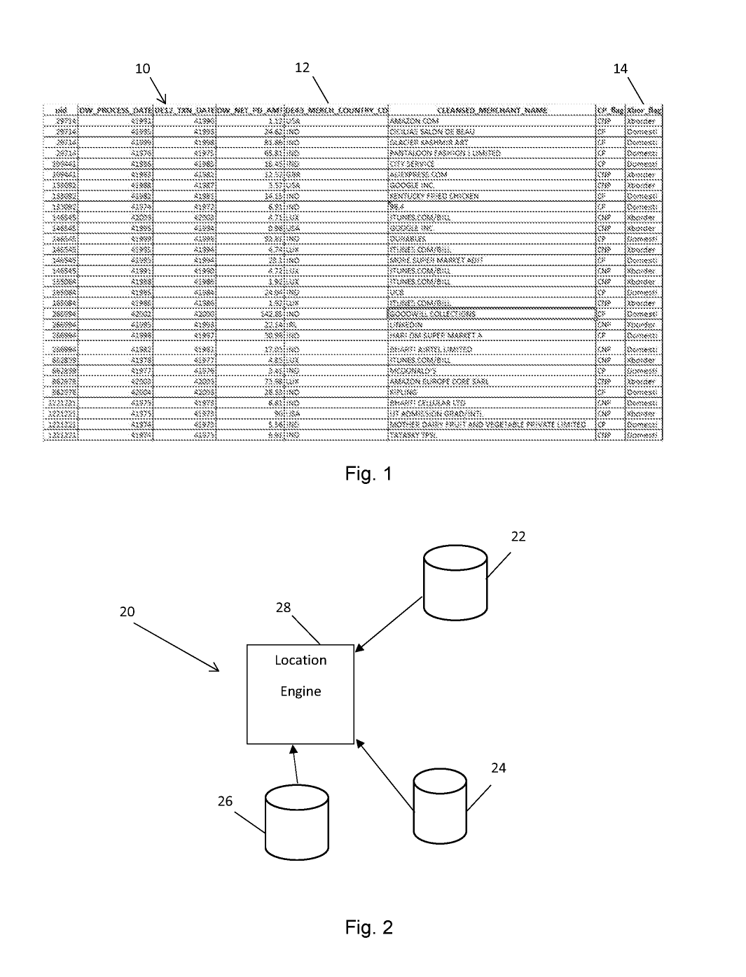

FIG. 2 shows a block diagram of a computer system 20 according to an embodiment of the present invention. The computer system 20 is configured to determine a cardholder's location when a CNP transaction takes place. It comprises an issuer database 22 storing issuer countries for payment cards; a transactional data database 24 storing one or more transactional data records characterising payment card transactions with a plurality of merchants; a merchant database 26 storing merchant countries where each merchant has a registered address and/or registered payment server; and a location engine 28.

The location engine 28 is operative to check whether an issuer country is the same as a merchant country for a particular payment card transaction, and, if so, determine that the cardholder is in the issuer/merchant country; otherwise the location engine 28 will carry out the following steps:
a) check whether, within a first pre-defined time frame, a cardholder performed a Card Present (CP) transaction;
b) if the answer to step a) is positive, determine the cardholder location as the location of the CP transaction that took place at a time closest to a time of the CNP transaction concerned;
c) if the answer to step a) is negative, check whether, within a second pre-defined time frame, a transaction was carried out with an airline, car rental or accommodation merchant and, if so, determine that the cardholder is in the country of the airline, car rental or accommodation merchant.

In this particular embodiment, the first pre-defined time frame is 7 days prior to or after the CNP transaction concerned and the second pre-defined time frame is 3 months prior to or 2 weeks after the CNP transaction concerned.

Although not shown, the computer system 20 may further comprise a GUI for presenting determined location information to a payment system operator. Furthermore, the computer system 20 may comprise a distributed system with one or more components (e.g. databases) distributed over a network (i.e. the internet). Alternatively, the computer system 20 may comprise a personal computer (PC).

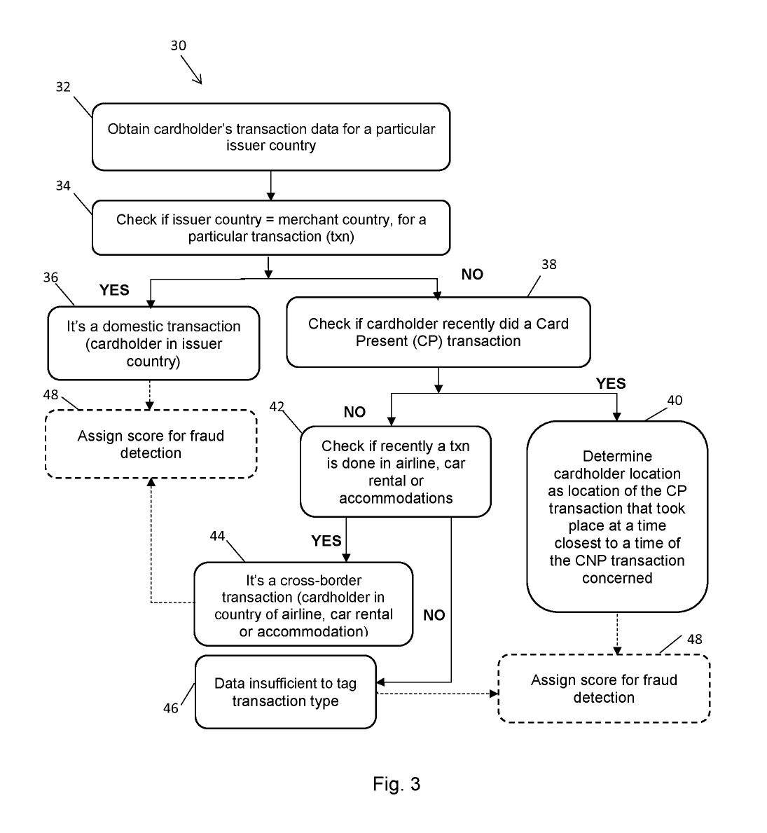

FIG. 3 shows a flowchart of a computerised method 30 for determining a cardholder's location when a CNP transaction takes place, according to an embodiment of the present invention. The method 30 may be implemented using the computer system 20 of FIG. 2.

The method 30 comprises the following steps:

Step 32: Obtain cardholder's transaction data for a particular issuer country. This includes receiving issuer countries for payment cards from the issuer database 22; receiving transactional data from the transactional data database 24 storing one or more transactional data records characterising payment card transactions with a plurality of merchants; and receiving merchant countries from the merchant database 26, where each merchant has a registered payment server or registered address;

Step 34: checking whether an issuer country is the same as a merchant country for a particular payment card transaction;

Step 36: if the answer to step 34 is YES, the transaction is flagged as a domestic transaction and it is determined that the cardholder is in the issuer/merchant country;

Step 38: if the answer to step 34 is NO, check whether, within a first pre-defined time frame, a cardholder performed a Card Present (CP) transaction;

Step 40: if the answer to step 38 is YES, the cardholder location is determined as the location of the CP transaction that took place at a time closest to a time of the CNP transaction concerned;

Step 42: if the answer to step 38 is NO, check whether, within a second pre-defined time frame, a transaction was carried out with an airline, car rental or accommodation merchant;

Step 44: if the answer to step 42 is YES, the transaction is flagged as a cross-border transaction and it is determined that the cardholder is in the country of the airline, car rental or accommodation merchant;

Step 46: if the answer to step 42 is NO, there is insufficient data to tag the transaction type.

Optionally, after one or more of steps 36, 40, 44, 46 there may be a further step 48 to assign a score for fraud detection based on the determined cardholder location when the transaction took place.

As for FIG. 2, the first pre-defined time frame in this embodiment is 7 days and the second pre-defined time frame is 3 months before or 2 weeks after, although other time frames could be used as appropriate.

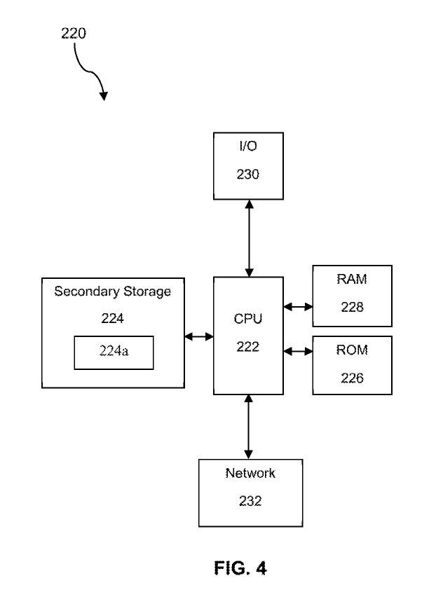

FIG. 4 is a block diagram showing a technical architecture of the location engine 28 configured for performing the method 30 which is described above with reference to FIG. 3. Typically, the method 30 is implemented by a computer server having a data-processing unit. The block diagram as shown in FIG. 4 illustrates a technical architecture 220 of a server which is suitable for implementing one or more embodiments herein.

The technical architecture 220 includes a processor 222 (which may be referred to as a central processor unit or CPU) that is in communication with memory devices including secondary storage 224 (such as disk drives), read only memory (ROM) 226, and random access memory (RAM) 228. The processor 222 may be implemented as one or more CPU chips. The technical architecture 220 may further comprise input/output (I/O) devices 230, and network connectivity devices 232.

The secondary storage 224 is typically comprised of one or more disk drives or tape drives and is used for non-volatile storage of data and as an over-flow data storage device if RANI 228 is not large enough to hold all working data. Secondary storage 224 may be used to store programs which are loaded into RANI 228 when such programs are selected for execution.

In this embodiment, the secondary storage 224 has a component 224a comprising non-transitory instructions operative by the processor 222 to perform various operations of the method of the present disclosure. The ROM 226 is used to store instructions and perhaps data which are read during program execution. The secondary storage 224, the RANI 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture 220 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 220. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It should be understood that by programming and/or loading executable instructions onto the technical architecture 220, at least one of the CPU 222, the RANI 228, and the ROM 226 are changed, transforming the technical architecture 220 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

In some embodiments the method may be performed by a payment system operator using a computer (PC) having downloaded appropriate software from a server. The PC may communicate with the location engine 28 to obtain data which is required, such as from databases 22, 24, 26.

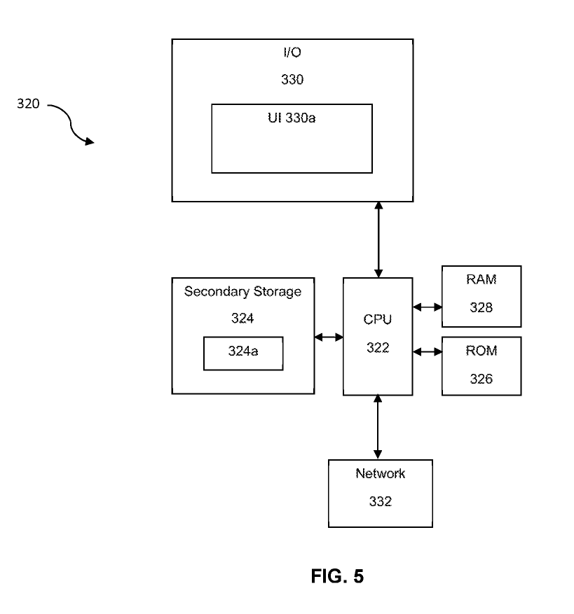

FIG. 5 is a block diagram showing a technical architecture of a PC for implementing embodiments of the invention. The block diagram as shown FIG. 5 illustrates a technical architecture 320 of a PC which is suitable for implementing one or more embodiments herein.

The technical architecture 320 includes a processor 322 (which may be referred to as a central processor unit or CPU) that is in communication with memory devices including secondary storage 324 (such as disk drives or memory cards), read only memory (ROM) 326, and random access memory (RAM) 328. The processor 322 may be implemented as one or more CPU chips. The technical architecture 320 further comprises input/output (I/O) devices 330, and network connectivity devices 332.

The I/O devices comprise a user interface (UI) 330a. The UI 330a may comprise a touch screen, keyboard, keypad or other known input device.

The secondary storage 324 is typically comprised of a memory card or other storage device and is used for non-volatile storage of data and as an over-flow data storage device if RANI 328 is not large enough to hold all working data. Secondary storage 324 may be used to store programs which are loaded into RANI 328 when such programs are selected for execution.

In this embodiment, the secondary storage 324 has a component 324a, comprising non-transitory instructions operative by the processor 322 to perform various operations of the method of the present disclosure. The ROM 326 is used to store instructions and perhaps data which are read during program execution. The secondary storage 324, the RANI 328, and/or the ROM 326 may be referred to in some contexts as computer readable storage media and/or non-transitory computer readable media.

The network connectivity devices 332 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 332 may enable the processor 322 to communicate with the Internet or one or more intranets. With such a network connection, it is contemplated that the processor 322 might receive information from the network, or might output information to the network in the course of performing the above-described method operations. Such information, which is often represented as a sequence of instructions to be executed using processor 322, may be received from and outputted to the network, for example, in the form of a computer data signal embodied in a carrier wave.

The processor 322 executes instructions, codes, computer programs, scripts which it accesses from hard disk, floppy disk, optical disk (these various disk based systems may all be considered secondary storage 324), flash drive, ROM 326, RAM 328, or the network connectivity devices 332. While only one processor 322 is shown, multiple processors may be present. Thus, while instructions may be discussed as executed by a processor, the instructions may be executed simultaneously, serially, or otherwise executed by one or multiple processors.

In embodiments of the invention, the location engine 28 may generate HTML or XML code which a browser of the PC can use to generate a window presenting data on a screen of the PC.

In accordance with embodiments of the invention, it will be understood that a CNP transaction will only be considered to be a cross-border CNP transaction when the card is actually overseas (i.e. not in its issuer country). Normally, the card will accompany the cardholder overseas, however, this may not be the case if the card details are obtained and used fraudulently. For online, overseas CNP transactions conducted by the cardholder from his/her card issuer country, the transaction will be flagged as a domestic CNP transaction.

By way of example, we can consider the case where Mr. X from India (i.e. with a card issued in India) performs a transaction from India with an online merchant in the USA. Without use of the present invention, this transaction would be classified as a cross-border transaction even if the cardholder has never been to the USA. However, in accordance with the present invention described above in relation to FIGS. 2 and 3, the location of the cardholder at the time of the CNP transaction could be determined (e.g. by virtue of an Indian CP transaction conducted around the time of the transaction in question) and, in this case, the transaction would be classified as a CNP domestic transaction.

If Mr. X later travels to the USA and, while there, makes another transaction with the online USA merchant, this would be correctly tagged as a cross-border transaction under both the old system and the improved method of the present invention (e.g. by virtue of the system recognising a transaction with a US accommodation merchant).

Accordingly, under the present invention it is possible to distinguish between CNP transactions initiated from a cardholder's home country and those conducted while the cardholder is in a foreign country.

In a further example, transactions with an international transportation merchant are all routed to the Netherlands regardless of whether the cardholder and service provided are in the same country. Without the present invention, such transactions would be tagged as CNP cross-border transactions. However, by using an embodiment of the present invention, it is possible to analyse the data to determine how comfortable a cardholder is in using the international transportation merchant in his/her home country when compared to when they are actually abroad.

In another example, a merchant may be interested to determine the share of online transactions that are performed by cardholders domestically versus internationally and this information can be derived from embodiments of the present invention.

Although only a single system and method according to embodiments of the present invention have been described in detail, many variations are possible in accordance with the appended claims. For example, additional information may be incorporated into the calculation of the fraud detection scores, such as any available data describing the typical frequency or level of spend of the cardholder. Furthermore, although the databases 22, 24, 26 are illustrated as being separate, any one or more of them may constitute portions of a single larger database.

1. A computer system for determining a cardholder location during a Card Not Present (CNP) transaction between the cardholder, using a payment card, and a merchant, the system comprising:
a first database having a database entry associated with the payment card, wherein the payment card has an issuer and the database entry associated with the payment card contains a country identifier for the issuer that identifies the issuer country;
a second database having at least one transactional data record for a transaction between the cardholder and at least one merchant using the payment card;
a third database having data for a plurality of merchants, including data for the merchant, wherein the data comprises a merchant country identifier for each of the plurality of merchants that identifies a country in which each of the plurality of merchants has at least one of a registered address and a merchant registered payment server; and
a location engine comprising a processor operable by instructions stored in memory, wherein the instructions, when executed by the processor, cause the processor, during use of the payment card during a CNP transaction with a first one of the plurality of merchants, to:
determine whether the issuer country for the issuer of the payment card is the same as the merchant country for the first one of the plurality of merchants, and, if so, identify the cardholder location as the issuer country/merchant country;
otherwise:
determine whether the payment card was used in a Card Present (CP) transaction within a first time frame comprising a plurality of times and having at least one time closest in time to the occurrence of the CNP transaction;
if the payment card was used in a CP transaction within the first time frame, identify the cardholder location as the location of a CP transaction merchant at which a CP transaction occurred at the at least one time closest in time to the occurrence of the CNP transaction; and
if the payment card was not in a Card Present (CP) transaction within the first time frame, determine whether the payment card was used in a transaction within a second time frame with a travel service merchant in a country and, if so, identify the cardholder location as the country of the travel service merchant.

2. The computer system according to claim 1, wherein the instructions, when executed by the processor, further cause the processor, during use of the payment card during a CNP transaction with a first one of the plurality of merchants, to assign a fraud score to the CNP transaction based upon the determination of whether the issuer country for the issuer of the payment card is the same as the merchant country for the first one of the plurality of merchants, and whether the payment card was used in a CP transaction within the first time frame.

3. The computer system according to claim 1, wherein at least one of the first and second time frames is defined by one of days and months from the occurrence date of the CNP transaction.

4. The computer system according to claim 1 wherein, the first time frame is one of 1, 2, 3, 4, 5, 6, 7, 10, 14, 21 and 30 days one of prior to the occurrence date of the CNP transaction, after the occurrence date of the CNP transaction, and prior to and after the occurrence date of the CNP transaction.

5. The computer system according to claim 1, wherein, the second time frame is one of 1, 2, 3, 4, 5, 6, 7, 10, 14, 21 and 30 days one of prior to the occurrence date of the CNP transaction, after the occurrence date of the CNP transaction, and prior to and after the occurrence date of the CNP transaction.

6. The computer system according to claim 1, wherein, the second time frame is one of 1, 2 or 3 months, one of prior to the occurrence date of the CNP transaction, after the occurrence date of the CNP transaction, and prior to and after the occurrence date of the CNP transaction.

7. A method for determining a cardholder location during a Card Not Present (CNP) transaction between the cardholder, using a payment card, and a merchant, the system comprising:
creating a first database having a database entry associated with the payment card, wherein the payment card has an issuer and the database entry associated with the payment card contains a country identifier for the issuer that identifies the issuer country;
creating a second database having at least one transactional data record for a transaction between the cardholder and at least one merchant using the payment card;
creating a third database having data for a plurality of merchants, including data for the merchant, wherein the data comprises a merchant country identifier for each of the plurality of merchants that identifies a country in which each of the plurality of merchants has at least one of a registered address and a merchant registered payment server; and
determining the cardholder location during a CNP transaction using a location engine comprising a processor operable by instructions stored in memory, wherein the instructions, when executed by the processor, cause the processor, during use of the payment card during a CNP transaction with a first one of the plurality of merchants, to:
determine whether the issuer country for the issuer of the payment card is the same as the merchant country for the first one of the plurality of merchants, and, if so, identify the cardholder location as the issuer country/merchant country;
otherwise:
determine a first time frame comprising a plurality of times and having at least one time closest in time to the occurrence of the CNP transaction;
determine a second time frame;
determine whether the payment card was used in the Card Present (CP) transaction within a first time frame
if the payment card was used in a CP transaction within the first time frame, identify the cardholder location as the location of a CP transaction merchant at which a CP transaction occurred at the at least one time closest in time to the occurrence of the CNP transaction; and
if the payment card was not in a Card Present (CP) transaction within the first time frame, determine whether the payment card was used in a transaction within the second time frame with a travel service merchant in a country and, if so, identify the cardholder location as the country of the travel service merchant.

8. The method according to claim 7, wherein the instructions, when executed by the processor, further cause the processor, during use of the payment card during a CNP transaction with a first one of the plurality of merchants, to assign a fraud score to the CNP transaction based upon the determination of whether the issuer country for the issuer of the payment card is the same as the merchant country for the first one of the plurality of merchants, and whether the payment card was used in a CP transaction within the first time frame.

9. The method according to claim 7, wherein at least one of the first and second time frames is defined by one of days and months from the occurrence date of the CNP transaction.

10. The method according to claim 7, wherein, the first time frame is one of 1, 2, 3, 4, 5, 6, 7, 10, 14, 21 and 30 days one of prior to the occurrence date of the CNP transaction, after the occurrence date of the CNP transaction, and prior to and after the occurrence date of the CNP transaction.

11. The method according to claim 7, wherein, the second time frame is one of 1, 2, 3, 4, 5, 6, 7, 10, 14, 21 and 30 days one of prior to the occurrence date of the CNP transaction, after the occurrence date of the CNP transaction, and prior to and after the occurrence date of the CNP transaction.

12. The method according to claim 7, wherein, the second time frame is one of 1, 2 or 3 months, one of prior to the occurrence date of the CNP transaction, after the occurrence date of the CNP transaction, and prior to and after the occurrence date of the CNP transaction.
